(19) United States
(12) Patent Application Publication
(10) Pub. No.: US 2026/0249390 A1
(43) Pub. Date: Aug. 27, 2026

(54) A DEVICE AND METHOD FOR MANIPULATING AN INNER SURFACE OF AN ELONGATED OBJECT

(71) Applicant: W2M Industries Oy, Vantaa (FI)

(72) Inventor: Juhani Tamminen, Vantaa (FI)

(21) Appl. No.: 18/877,424

(22) PCT Filed: Jun. 20, 2023
(86) PCT No.: PCT/FI2023/050370

§ 371 Date: Dec. 20, 2024

(30) Foreign Application Priority Data
Jun. 20, 2022 (FI) 20225554

(51) Int. Cl. B23K 26/142; F16L 55/26

(52) U.S. Cl. CPC B23K 26/142; F16L 55/26

(57) ABSTRACT

A device for manipulating an inner surface of an object comprises a laser beam directing device for directing a laser beam onto the inner surface of the object to manipulate the inner surface of the object and thereby provide structural changes to, remove a material from and/or add material to said inner surface of the object at the location the laser beam directing device directing said laser beam. The device comprises also a moving device configured to move the laser beam directing device inside the object thereby manipulating the inner surface of the object in the direction of the longitudinal axis. The object may be e.g. an elongated cylindrical object having a longitudinal axis essentially parallel with the inner surface of the object

### TECHNICAL FIELD OF THE INVENTION

The invention relates to a device and method for manipulating an inner surface of an elongated object. In particularly, the invention relates to a device and method for manipulating, such as cleaning, machining, milling, grinding, polishing, or tempering, and especially to removing or heat treating a certain depth layer of material from/in the inner surface of an elongated object.

### BACKGROUND OF THE INVENTION

Different kinds of pipes, for example, are used in industry to conduct various substances, such as oil pipes, process pipes, but also other elongated pipe like objects, such as cannon or gun barrels. Common for these objects or pipes is that their inner surfaces need from time-to-time maintenance or manipulation, such as cleaning, so to remove excess of material from the inner wall surface of the object, such as the pipe.

Different types of devices and methods are known from prior art used for manipulation, such as cleaning, the inner surfaces of these kind objects. For example, a traditional way is to mechanically clean the inner surface of the object, such as a bottle brush type mechanisms or sandblasting. Also, aggressive chemicals are used for cleaning the inner surface of the object.

However, there are some problems related to the prior art methods, such as the mechanical manipulating systems are very time consuming (taking even days), might consists of several operational steps and typically also very inaccurate, namely often residues still remain on the inner surface after manipulation and the results are uneven or rough, because it is demanding to measure the quality or effects of the mechanical manipulation at the same time when manipulating. The sandblasting and aggressive chemicals are in turn harmful to the environment and should thus therefore be avoided.

Chemical and food industries use typically an acid-based rinsing method, which is problematic especially in the food industry, as solids are difficult to dissolve with chemicals permitted by operators or authorities. Alternatively, in an event of a blockage, the pipe will have to be cut to clean it.

### SUMMARY OF THE INVENTION

An object of the invention is to alleviate and eliminate the problems relating to the known prior art. Especially the object of the invention is to provide a fast, accurate and in particularly environmental device and method for manipulating different kinds of objects, especially elongated object, such as pipes and in particularly cylindrical pipes.

The object of the invention can be achieved by the features of independent claims.

The invention relates to a device for manipulating an inner surface of an elongated object according to claim 1. In addition, the invention relates to a method for manipulating an inner surface of an elongated object according to claim according to claim 24.

According to an embodiment a device for manipulating an inner surface of an elongated object comprises a laser beam directing device for directing a laser beam onto the inner surface of the object. The object is advantageously an elongated object having a longitudinal axis essentially parallel with the inner surface of the elongated object. According to an advantageous embodiment the elongated object is a cylindrical object, such as a pipe, oil pipe, process pipe, or cannon or gun barrels, for example. However, the invention is not limited only to the cylindrical objects, but the cross section of the object can also be an oval or rectangular, for example.

The laser beam is provided to manipulate the inner surface of the object and advantageously to provide plasma reactions to material in the inner surface of the object. The material in the inner surface of the object may be e.g. residues of medium transported inside the object or residues of gunpowder in the case where the object is the cannon or gun barrel, for example. Due to the plasma reactions structural changes can be achieved to the material to be manipulated, whether the material was residue on the inner surface of the object or structure material of the object itself. One plasma reaction is short in time (e.g. milliseconds) and because its parameters, such as amplitude, wavelength, frequency, pulse width and power, as well as process speed (how fast the device is moved inside the object), can be precisely adjusted, one plasma reaction is very gentle. However, exposing plurality of plasma reactions is very effective method to provide structural changes to the material on the inner surface of the object and thus remove the object and thereby clean the inner surface of the object.

It is to be noted that less energy is required to provide structural changes to the residue material on the inner surface of the object than provide structural changes to the object itself, so there is an “energy threshold”. This energy threshold information can be used to select suitable parameters for the laser beam so whether the laser beam is used for manipulating the material on the inner surface of the object or the material of the object itself. Therefore, by selecting suitable parameters for the laser beam to be used, cleaning, machining, milling, grinding, polishing, or tempering, and especially removing or heat treating a certain depth layer of material on or in the inner surface of the object can be achieved. Also, suitable parameters for the laser beam to be used can be selected to add and attach material to the inner surface of the object, such as making a bond between the material and the inner surface, whereupon the device of the invention can be used for coating the inner surface of the object.

It is to be noted that more than one laser beams can be used so that for example the first laser beam has first parameters for power, amplitude and wavelength, for example, whereas the second laser beam has second parameters, whereupon for example the first laser beam may cause plasma reactions to the material on the inner surface of the object and the second laser beam may remove the material and having cleaning effect or attach, such as make on bond between the material and the inner surface of the object, such as melt the material to be added to the inner surface of the object. The material to be added can be provided by different methods, such as using a feeding device described in more details elsewhere in this document.

According to an embodiment the device is configured to provide a first laser beam with first power and other parameters (like amplitude and wavelength etc.) to provide a first manipulation effect, such as plasma reactions to material in the inner surface of the object and to be removed, for example. In addition, the device may also be configured to provide a second laser with second power and other parameters (like amplitude and wavelength etc.) to provide a second manipulation effect, such as removing and cleaning the material already exposed to the plasma reactions. Typically, for example when removing the material from the inner surface of the object, the power of the first laser beam is higher than the power of the second laser beam. The first and second laser beams may be sequential laser beams or exposed simultaneously at the same time. Also, other variations can be implemented, such as moving the laser beam directing device first in the direction of longitudinal axis of the object in a first direction using the first laser beam and then returning or retracting back to opposite direction and using the second laser beam. In addition, it is to be noted that also more than only two different laser beams can be used, depending on the needs.

According to an example, the first laser beam may be generated e.g. by a CW type laser (continuous wave) and the second laser beam e.g. by a MOPA type laser (Master Oscillator Power Amplifier), where the CW typically soften the material to be removed and the MOPA removes the material and cleans the inner surface of the object.

According to an embodiment the laser beam directing device is a mirror or prism or crystal, which is arranged inside the object during use so that the device receives the laser beam from a laser source and directs the laser beam to the inner surface of the object. The laser source is advantageously an external laser source outside the object, but it is to be understood that the inventive concept of the current invention is not limited to any special laser source. The device comprises a laser beam input for receiving the laser beam from the laser source and a laser beam guiding device to guide the laser beam from the laser beam input to the laser beam directing device.

According to an advantageous embodiment the laser beam directing device is a rotating laser beam directing device and in particularly rotating mirror rotating around its rotational axis or a rotating prism or crystal rotating around its rotational axis. The rotational axis is advantageously adjustably and it is adjusted essentially parallel to the longitudinal axis of the object. When the rotating, the rotating laser beam directing device advantageously directs the laser beam radially towards the inner surface of the object and extending over an entire inner perimeter of the inner surface of the object at the location the rotating laser beam directing device directs the laser beam during rotation.

According to an embodiment the surface of the laser beam directing device from which the laser beam enters into and outputs from is coated by an anti-reflective material so to minimize any unwanted reflections. In addition, the surface of the laser beam directing device from which the laser beam is reflected or refracted (in the crystal advantageously only one surface) is coated by di-electric material or film in order to maximize the reflection or refraction.

According to an embodiment the coating material of the laser beam directing device is advantageously thermally conductive so to improve cooling of the laser beam directing device during use. In particularly, when the crystal is used, the laser beam directing device is arranged so that the laser beam reflects or refracts only from the one surface of the crystal in order to minimize reflections or refractions. Therefore, when the crystal is used and only one surface is used, the power dissipation of the beam and also heating of the laser beam directing device is minimized.

According to an example the rotating laser beam directing device is the rotating mirror. When the mirror is used, it is advantageously arranged in a setting angle in relation to the rotational axis and to the longitudinal axis of the elongated object so to direct and guide the laser beam to the inner surface of the object. The setting angle can be advantageously adjusted and is advantageously between 25-50° in relation to the received laser beam, whereupon the laser beam hits the inner surface of the object also in a hitting angle, which is essentially perpendicular, when the laser beam hits the mirror surface in the angle of 45°. However, when the setting angle deviates from the angle of 45°, possible direct reflections back to the mirror from the inner surface of the object can be avoided, thus prolonging life of the mirror and possible other optics of the systems, because the mirror otherwise reflects the back reflecting beams back to the optics of the device. In particular, the back reflected laser beam heats the mirror, optics, and the device, especially if the mirror or optics is dusty or dirty.

According to another embodiment the laser beam directing device is a prism or crystal, which can also be a rotating prism or crystal and arranged in a setting angle in relation to the rotational axis and to the longitudinal axis of the elongated object so to direct and guide the laser beam to the inner surface of the object correspondingly with the example of the mirror above. According to an embodiment, the laser beam directing device, such as the prism or crystal, comprises number of holes to increase a surface area of the prism or crystal and thereby increase heat transfer from the material of the prism or crystal to the surfaces of the holes and thus improving a cooling effect. Moreover, according to an embodiment, the device comprises a fluid flow providing device, such as a fan, for providing fluid flow through the holes to enhance cooling of the laser beam directing device. The diameters of the holes are typically at the range of 0.1-0.8 mm.

The device may also comprise a feeding device for feeding material and to add said material to said inner surface of the object at the location to which the laser beam directing device is directing said laser beam. The feeding device comprises a conduit and a nozzle to feed the material. The nozzle may be controllable so to focus the feeding of the material in a desired point, so to the point where the laser beam is hitting the inner surface of the object. The laser beam is advantageously configured to interact with the material and/or the inner surface of the object to attach, so make a bond between the material to be added and the inner surface, such as melt, the material to the inner surface of the object. It is to be noted that the surface may be cleaned, or material may be removed from the inner surface as described elsewhere in this document before adding the material. In addition, also two laser beams may be used for attaching the material to the inner surface of the object. The material to be added and fed by the feeding device may comprise small particles or it may be fed in a fluid or gas format.

In addition, the device advantageously comprises also a moving device for moving the laser beam directing device inside the object. Advantageously the moving device moves the laser beam directing device inside the object in a controlled manner and essentially in the longitudinal direction of the object so that the laser beam directing device can direct the laser beam to the inner surface of the object in a desired way. Advantageously, speed and orientation of the moving device can be controlled. According to an embodiment, the moving device comprises suitable number of wheels or the like, the distances of which from the device (or from the inner surface) can be controlled separately so that the device can be supported to the inner surface of the object. Therefore, the device can be used inside of different diameter objects (for example 25-500 mm, however not limiting to this range). In addition, the moving device is configured to align the laser beam directing device for example so that the rotational axis of the rotating laser beam directing device is at the center line and at the longitudinal axis of the object. In this way the focus point of the laser beam hitting on the inner surface of the cylindrical object is adjusted overall the entire perimeter of the object. However, it is to be noted that the rotational axis of the rotating laser beam directing device can also be aligned next to a center line (asymmetrically) and the longitudinal axis of the object, whereupon the focus of the laser beam is sharp only in a certain arch of the inner surface perimeter of the object. This might be advantageous if only a certain portion or arch of the entire perimeter of the inner surface of the object is to be manipulated with. Alternatively, rotational the axis of the rotating laser beam directing device can be aligned symmetrically to the center line and at the longitudinal axis of the object and the laser beam can be put on and off sequentially so then when rotating the rotating laser beam directing device directs the laser beam only to a certain desired portion of the inner surface of the object.

Even if the wheels are mentioned above as an example component of the moving device, the moving device may also comprise (in addition to at least one wheel or instead of the wheels) tracks, like rubber tracks, rollers, at least one ski and/or at least one ball configured to support the device into the inner surface of the object in a movable manner.

In addition, according to an advantageous embodiment the device comprises a control unit, memory device and possibly also communication device for receiving and storing to the memory device and possibly also sending information advantageously in a wireless manner, such as via Bluetooth or the like, as well read information from the memory device. The control unit is advantageously configured to control the operational parameters of the device, such as speed of the moving device, aligning of laser beam directing device, rotation speed of the laser beam directing device, and possibly also controlling or at least sending control commands to the laser source to adjust the parameters, such as power, amplitude and/or wavelength, frequency, pulse width and duration of the laser beams, as an example. The control unit may also control the feeding device for feeding the material to be added add said material to said inner surface of the object to the location where the laser beam directing device is directing the laser beam. In addition, the feeding device comprises also a conduit and a suitable nozzle to feed the material so that the laser beam can interact with the material and attach it to the surface.

The device and the control unit may be for example provided with information about threshold energy required for the first laser beam to induce or cause material changes to the inner wall structure of the object itself, whereupon the control unit may control the laser source to provide laser beam with energy just below the threshold energy so that the residual material to be removed, for example, is manipulated, like softened, but no harmful effects are cause to the material of the object itself. It is to be understood that also other parameters discussed in this document can be adjusted according to the need and materials and other conditions.

According to an embodiment the device comprises a detecting device (e.g. a camera, ultrasound or other type analysis system known by the skilled person, such as optical systems) for detecting the inner surface of the object, and for example depth of the layer of the material to be removed. The detecting device may detect for example changes of the structure or material of the inner wall of the object when the power of the first laser beam exposed to the inner wall surface of the object is increased and output a signal to the control unit defining a threshold energy when changes in the residual material to be removed or in the structure or material of the inner wall of the object due to increased power of the first laser beam is detected, whereupon the control unit may control the laser source to decrease the power of the first laser beam so that the energy exposed by the first laser beam to the inner wall surface of the object is below said threshold energy causing material changes to the structure of the object after said decreasing, but still having effects to the residual material to be removed, for example. Similarly, the detecting device may also detect effects of other manipulation, such as based on the reflections and reflection parameters (such as brightness, polarisation, colour, or the like) whether the parameters of the used laser beam cause desired effect to the material to be manipulated on or in the inner surface of the object, such as for example polishing, or tempering the inner surface of the object after residual material removing. Advantageously the detecting device send information relating to the detected parameters, whereupon the control unit can control the device (such as the speed of the moving device or rotational speed of the laser beam directing device, or the like, as is discussed elsewhere in this document) or the laser source or send the information a receiver. This is clear advantage namely the device can run the operation and manipulation automatically and also in repeated manner, and also make and store e.g. diagnostic data of the object in question, which data can be used afterwards for example selecting suitable parameters for different manipulations or for detecting changes in condition of the object or make life expectancy of the object.

In addition, it is to be noted that the control unit together with the detecting device and/or the moving device may compose a coordinate system for the object and map there detected parameters with time stamp, for example, such as how much residual material is removed and by which laser beam or other parameters said residual material or the inner surface of the object itself is manipulated. The moving device may for example measure distance from the open end of the object and an angle detection meter may measure the angle to which the detecting device is measuring or to which the laser beam is exposed. Based on those an accurate coordinate point can be determined and provided with suitable or desired information and stored to the memory device for example later use or sending said information via the communication device outside the device.

In addition, according to an embodiment the control unit may compare the determined values or information to preset values or library values, for example, and for example increasing the power of the laser until the preset values or library values as achieved.

In addition, according to an embodiment the device may determine e.g. a roughness of the inner surface determining so called Ra value. For this possible heave of the inner surface should be determined, which can be done for example by the detecting device, thereby providing a primary profile of the inner surface of the object.

Further, the control device may control the laser source or a possible shutter so that the laser beam is exposed only to a certain peripheral area and so that at least one parameter (power, duration, wavelength, amplitude, or the like) of the laser beam directed onto the inner surface is different in a first peripheral area than in a second peripheral area of the inner surface of the object, thereby providing different manipulation effect to different peripheral areas. Naturally these parameters can be adjusted also in relation to the longitudinal axis of the object.

According to an embodiment the device comprises also a cooling arrangement for cooling the laser beam directing device. The cooling arrangement comprises advantageously a connection to an auxiliary cooling device and suitable channels and guiding deflectors to guide the cooling flow via the connection, channels and guiding deflectors to the laser beam directing device. The cooling arrangement may also comprise e.g. heat dissipators and radiators.

Still in addition and according to an advantageous embodiment, the device comprises a fluid flow providing device providing a fluid flow next to the laser beam directing device to keep an aperture area of the laser beam directing device clean from the material removed from the inner surface of the object by the device. According to an example the fluid flow providing device may comprise a fan or suitable conduits and controls or guiding means for guiding the fluid flow advantageously next to the laser beam directing device. It is to be noted that e.g. air or other gases can be used, and e.g. nitrogen or helium or the like, in a flammable environment.

Further, the device comprises also a transporting arrangement transporting the material removed from the inner surface of the object. The transporting arrangement may comprise e.g. a vacuum device for sucking the material away from the cylindrical object or a fan or even a conveyor belt.

The present invention offers advantages over the known prior art, such as enables very easy, simple, reliable, and fast way to manipulate the inner surfaces of different kinds of objects, such as elongated and cylindrical objects, like pipes, oil pipes, process pipes, but also other elongated pipe like objects, such as cannon or gun barrels. In addition, the manipulation can be determined by the parameters of the laser beam used and may comprises for example cleaning, machining, milling, grinding, polishing, or tempering, and removing or heat treating a certain depth layer of material from or in the inner surface of the object.

The present invention offers very environmentally friendly as well as accurate device and method for manipulating the inner surfaces of the objects. In addition, the device can be self-employed and automated, as well as self-learning.

The exemplary embodiments presented in this text are not to be interpreted to pose limitations to the applicability of the appended claims. The verb “to comprise” is used in this text as an open limitation that does not exclude the existence of also unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

### BRIEF DESCRIPTION OF THE DRAWINGS

Next the invention will be described in greater detail with reference to exemplary embodiments in accordance with the accompanying drawings, in which:

FIGS. 1-3 illustrate perspective views of an exemplary device for manipulating an inner surface of an elongated object according to an advantageous embodiment of the invention,

FIG. 4 illustrates a cross-section view of an exemplary device for manipulating an inner surface of an elongated object according to an advantageous embodiment of the invention,

FIGS. 5-7 illustrate schematic views of an exemplary device during used for manipulating an inner surface of an elongated object according to an advantageous embodiment of the invention,

FIG. 8 illustrates an exemplary angle of the laser directing device and the laser beam hitting it according to an advantageous embodiment of the invention,

FIG. 9 illustrates a view of an elongated object, where the device for manipulating an inner surface of object is in use according to an advantageous embodiment of the invention,

FIG. 10 illustrates an exemplary feeding device for feeding material to be added according to an advantageous embodiment of the invention, and

FIGS. 11-12 illustrate examples of the laser beam directing devices according to an advantageous embodiment of the invention.

### DETAILED DESCRIPTION

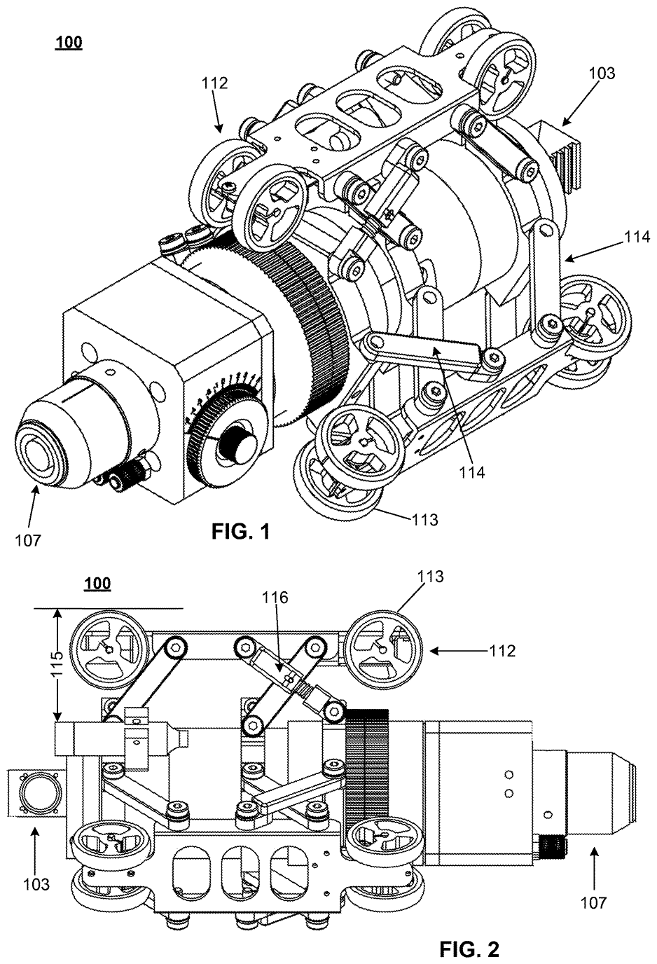

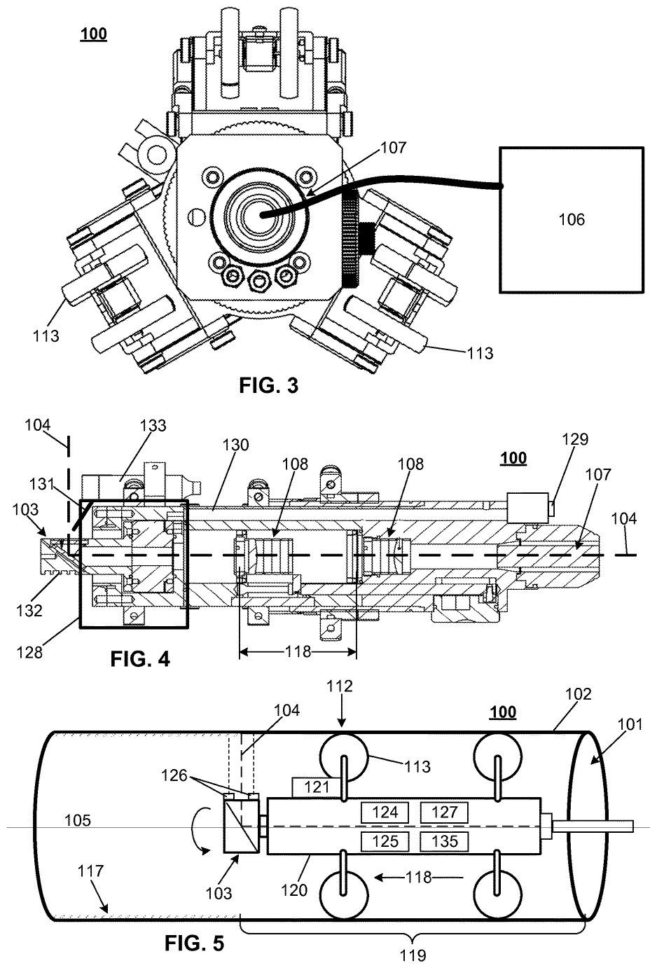

FIGS. 1-3 illustrate perspective views of an exemplary device 100 for manipulating an inner surface 101 of an elongated object 102 according to an advantageous embodiment of the invention, where the device comprises a laser beam directing device 103 for directing a laser beam 104 onto the inner surface of the object and a moving device 112 for moving the laser beam directing device 103 inside the object 102. In the examples illustrated in figures the moving device 112 comprises suitable number of wheels 113, which can be adjusted against the inner surface 101 of the object so that the device can be supported against the inner surface 101 of the object advantageously in three different locations. However, the invention is not limited to this only, but also other types of moving devices can be used, such as for example a crawling or dragging type devices or device with two-wheel pairs, when the device is moved typically at a bottom of the object inner wall. The moving device 112 advantageously comprises a motor 115 providing drive or traction to at least one wheel supported to the inner surface of the object.

The adjusting of the wheels 113 can be implemented e.g. by telescope arms or a scissor lift system 114 connected from first ends to the device and from the second end to the wheels, where for example the length or angle of the telescope arms or scissor lift system 114 can be controlled and thus the distance 115 of the wheels 113 from the device body (and thus also from the inner surface of the object) can be changed, thereby fit the device inside the different diameter objects. The telescope arms or scissor lift system 114 may e.g., comprise a controllable screw 116, which lengthens or shortens at least one arm when rotated and thus enables the adjustment.

Advantageously, the device comprises a driving motor 121 for controlling speed of the moving device 112. In addition, also orientation of the moving device can be controlled for example by the telescope arms or scissor lift system 114 connected to the wheels or the like.

As discussed elsewhere in this document, the distances of wheels (or the like) from the device or the inner surface 101 of the object 102 can be controlled separately so that the device can be both orientated but also supported to the inner surface of the object. The device can be supported e.g., at least two, advantageously in three different locations symmetrically around the longitudinal axis 105 of the object and thus moved inside the object 102 essentially parallel to the longitudinal axis of the object.

FIG. 4 illustrates a cross-section view of an exemplary device 100 for manipulating an inner surface of an elongated object according to an advantageous embodiment of the invention. The device comprises a laser beam input 107 for receiving the laser beam 104 from the laser source 106 and a laser beam guiding device 108 to guide the laser beam 104 from the laser beam input 107 to the laser beam directing device 103 and again to the inner surface 101 of the object 102. The laser beam guiding device 108 may comprise for example mirrors, prisms, crystals and/or lenses used to guide the laser beam and to change the focus point of the laser beam 104 in a desired way. For example, the changing diameter of the inner surface of the object requires refocusing the focus point of the laser beam 104 and this is advantageously implemented by the laser beam guiding device 108. According to an embodiment the laser beam guiding device 108 comprises two or more lenses 108 the distance 118 of which can be controlled and thereby the focal point of the laser beam 104 on the inner surface of the object can be controlled.

FIGS. 5-7 illustrate schematic views of an exemplary device 100 during used for manipulating an inner surface 101 of an elongated object 102 according to an advantageous embodiment of the invention. The object has a longitudinal axis 105, which is essentially parallel with the inner surface 101 of the object 102.

FIGS. 5-7 nicely show the laser beam 104 manipulating the inner surface 101 of the object 102 and providing plasma reactions to the material 117 in the inner surface 101 of the object 102. The material 117 in the inner surface of the object is e.g., residues of medium transported inside the object or residues of gunpowder in the case where the object is the cannon or gun barrel, and its depth is denoted by 136 in FIG. 7. In addition, in the examples illustrated in figures the laser beam directing device 103 is a rotating mirror, but this is only for example and also other type of laser beam directing devices can be used as discussed elsewhere in this document, such as the prism or crystal.

The rotating mirror 103 rotates around its rotational axis 109 (show in FIG. 8) and thereby directs the laser beam 104 radially towards the inner surface 101 of the object 102 and extending over an entire inner perimeter 110 of the inner surface 101 of the object 102 at the location the rotating laser beam directing device 103 directs the laser beam 104 during the rotation. According to an embodiment only an arch or portion of the entire perimeter is exposed, as can be seen e.g., in FIG. 9, and as is discussed elsewhere in this document. The rotational axis 109 is advantageously adjustable and it can be adjusted essentially parallel to the longitudinal axis 105 of the object 102, as is the case e.g. in FIGS. 5-7.

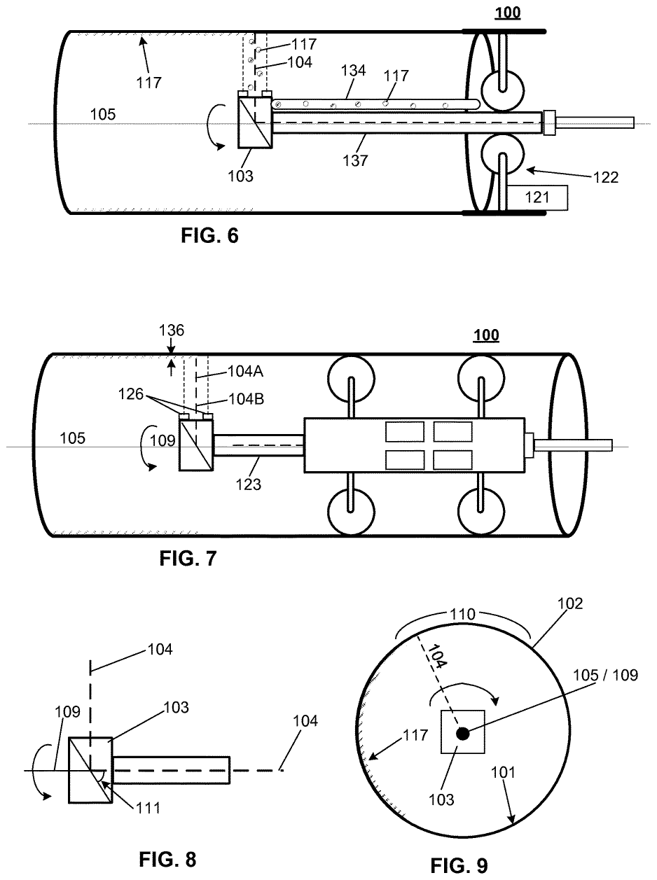

FIGS. 5-7 describes few examples of the moving device 112 moving the laser beam directing device 103 inside the object essentially in the longitudinal direction 105 of the object 102 so that the laser beam directing device can direct the laser beam 104 to the inner surface 101 of the object 102 in a desired way. In FIGS. 5-7 the moving device 112 has moved the laser beam directing device 103 in the direction of the arrow 118 and thus the laser beam 104 has already manipulated, or here removed the material 117 from the inner surface 101 of the object 102 in the area 119 behind the laser beam 104. In FIG. 6 it can be seen how the material 117 is removed by the laser beam 104 from the inner surface 101 of the object 102.

FIG. 5 illustrates an example, where the moving device 112 comprises wheels 113 supported to the inner surface 101 of the object and carries the body of the device comprising e.g., the laser beam directing device 103. The device comprises also the telescope arms 114 connected from first ends to the device body 120 and from the second end to the wheels 113.

FIG. 6 illustrates an example, where the moving device 112 is implemented by a supplying device 122, such as rollers, arranged outside the object and advantageously near the open end of the object, and supported to the device body or other arm 137 supporting the laser beam directing device 103. The moving device 112 in FIG. 6 comprises also a driving motor which drives the supplying device, such as at least one roller or other when, which again supplies or feeds the arm 122 or the like essentially in the direction of longitudinal axis 105 of the object 102. The moving device 112 can be used advantageously both pushing and/or pulling the laser beam directing device 103 inside the object. It is to be noted that according to an embodiment the laser beam directing device 103 can be transported to the opposite end by any suitable method and the moving device 112 in the FIG. 6 is used just pulling the laser beam directing device 103 in a controlled way back to the moving device 112.

FIG. 7 illustrates still another example, where the device 100 comprises an elongated and extendable/retractable leg 123. The first end of the leg 123 is coupled advantageously with the moving device 112 and the laser beam directing device 103 is advantageously coupled to the second end of the leg 123. Now, when the moving device 112 moves the laser beam directing device 103 inside the object, the extendable/retractable leg 123 can be used for example passing the laser beam directing device 103 over a possible obstacle in the object, such as for example flange or collar or grooves or other bumps, in a smooth, precise, and stable way. In this case the moving device 112 may stop its movement and the laser beam directing device 103 is moved by the extendable/retractable leg 123.

The device may also comprise a control unit 124 connected with a memory device 125 and possible communication device 127 for receiving, storing and/or sending data. The device may also comprise one or more detecting devices 126 (e.g., a cameras, IR cameras, ultrasound devices or the like and combination thereof) for detecting different features and characters of the inner surface of the object. Moreover, the device may also comprise an energy storage 135, such as a battery, for feeding energy e.g. to the control unit 124, but it is to be noted that this is optional. As discussed elsewhere in this document, the control unit 124 is then advantageously configured to control e.g., the operational parameters of the device, such as speed of the moving device, aligning of laser beam directing device, rotation speed of the laser beam directing device, and possibly also controlling or at least sending control commands to the laser source to adjust the parameters, such as power, amplitude and/or wavelength and duration of the laser beams. The control unit 124 may also control the feeding device 139 for feeding the material, as well as also controlling the nozzle into the desired direction.

The device may also comprise a cooling arrangement 128 for cooling the laser beam directing device 103. The cooling arrangement 128 comprises advantageously a connection 129 to an auxiliary cooling device and suitable channels 130 and guiding deflectors 131 to guide the cooling flow via the connection, channels and guiding deflectors to the laser beam directing device 103. The cooling arrangement 128 may also comprise e.g. heat dissipators and radiators 132.

The device may also comprise a fluid flow providing device 133 providing a fluid flow next to the laser beam directing device 103 to keep an aperture area of the laser beam directing device 103 clean from the material 117 removed from the inner surface 101 of the object 102 by the device 100.

Further, the device may also comprise a transporting arrangement 134 transporting the material 117 removed from the inner surface of the object 102.

FIG. 8 illustrates an exemplary angle 111 by which the laser beam 104 hits the laser beam directing device 103 or the rotating mirror 103 of the device. The mirror is advantageously arranged in the setting angle 111 in relation to the rotational axis 109 and to the longitudinal axis of the elongated object so to direct and guide the laser beam 104 to the inner surface 101 of the object 102, as is discussed elsewhere in this document. The setting angle can be advantageously adjustable.

FIG. 9 illustrates a view of an object 102, where the device 100 for manipulating an inner surface 101 of the object 102 is in use according to an advantageous embodiment of the invention.

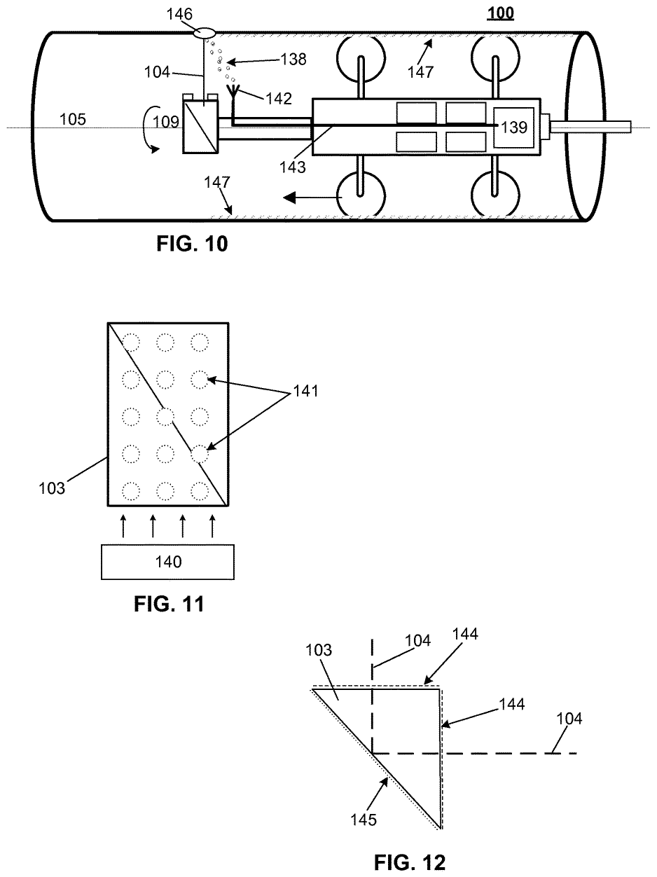

FIG. 10 illustrates an exemplary feeding device 139 for feeding material 138 to be added to the inner surface of the object according to an advantageous embodiment of the invention. The feeding device 139 may comprise a pump or the like to deliver the material via a conduit 143 to the nozzle 142, which again guides the material to the desired position on the inner surface. As can be seen in FIG. 10, the material to be added is guided to the area or location 146 to the laser beam 104 is also directed so that the laser beam can interact with the material and/or the inner surface of the object so that the end result is e.g. a coating 147 on the inner surface of the object.

FIGS. 11-12 illustrate examples of the laser beam directing devices 103 and in particularly a crystal, where the crystal comprises number of holes 141 to increase a surface area of the crystal. The exemplary devices comprises also a fluid flow providing device 140, such as a fan, for providing fluid flow through the holes 141 and thereby to enhance cooling of the laser beam directing device 103.

As can be seen in FIG. 12, the surfaces 144 of the laser beam directing device from which the laser beam enters into and outputs from is coated by an anti-reflective material so to minimize any unwanted reflections. In addition, the surface 145 of the laser beam directing device from which the laser beam is reflected or refracted (in the crystal advantageously only one surface) is coated by di-electric material or film in order to maximize the reflection or refraction.

The invention has been explained above with reference to the aforementioned embodiments, and several advantages of the invention have been demonstrated. The invention is not only restricted to these embodiments but comprises all possible embodiments within the spirit and scope of the inventive thought and the following patent claims.

The features recited in dependent claims are mutually freely combinable unless otherwise explicitly stated.

1. A device for manipulating an inner surface of an object having a longitudinal axis essentially parallel with the inner surface of the object, wherein the device comprises
a laser beam directing device for directing a laser beam onto the inner surface of the object to manipulate the inner surface of the object and thereby provide structural changes to, remove a material from or to add material to said inner surface of the object at the location the laser beam directing device directing said laser beam and
a moving device configured to move the laser beam directing device inside the object thereby manipulating the inner surface of the object in the direction of the longitudinal axis.

2. A device of claim 1, wherein the laser beam directing device is configured to receive the laser beam from a laser source and direct said laser beam onto the inner surface of the object, and wherein the device comprises a laser beam input for receiving the laser beam from the laser source and a laser beam guiding device to guide the laser beam from the laser beam input to the laser beam directing device.

3. A device of claim 1, wherein the laser beam directing device is a rotating mirror rotating around its rotational axis, said rotational axis being adjustable essentially parallel to the longitudinal axis of the object, and thereby directing the laser beam radially towards the inner surface of the object and extending over an entire inner perimeter of the inner surface of the object at the location the rotating mirror as said laser beam directing device directing said laser beam when the rotating mirror is rotated.

4. A device of claim 3, wherein the mirror is arranged in a setting angle in relation to said rotational axis or the longitudinal axis of the object so to direct and guide said laser beam to the inner surface of the object, where the setting angle between 25-50°.

5. A device of claim 1, wherein the laser beam directing device is a prism or a crystal, and wherein the laser beam directing device is arranged so that it has one surface from which the laser beam reflects and said surface is coated by di-electric film and the surfaces interacting otherwise by the laser beam, so an input and output, are coated by an anti-reflective material.

6. A device of claim 5, wherein the prism or a crystal comprises number of holes to increase a surface area of the laser beam directing device and thereby increase heat transfer from the material of the prism or the crystal to the surfaces.

7. A device of claim 6, wherein the device comprises a fluid providing device, such as a fan, for providing fluid flow through the holes of the laser beam directing device to enhance cooling of the laser beam directing device

8. A device of claim 1, wherein the device is configured to provide a first laser beam to provide plasma reactions to the material to be removed from the inner surface of the object and to provide a second laser beam to clean the inner surface of the object from the material exposed to said plasma reactions with the first laser beam, wherein the power of the first laser beam is higher than the power of the second laser beam or wherein the wavelength of the first laser beam is different than the wavelength of the second laser beam.

9. A device of claim 1, wherein the device comprises a feeding device for feeding material and to add said material to said inner surface of the object at the location to which the laser beam directing device is directing said laser beam.

10. A device of claim 1, wherein the feeding device comprises a conduit and a nozzle to feed the material, whereupon the laser beam is configured to interact with the material or the inner surface of the object to attach, such as melt, the material to the inner surface of the object.

11. A device of claim 1, wherein the device comprises a control unit (124) and wherein the device is provided with information, said information defining threshold energy required for the first laser beam to induce material changes to the inner surface of the object, whereupon the control unit is configured to control and adjust the power of the first laser beam so that the energy of the first laser beam exposed to the inner surface of the object is below said threshold energy.

12. A device of claim 1, wherein the device comprises a control unit and a detecting device for detecting changes of the structure or material of the inner surface of the object when the power of the first laser beam exposed to the inner surface of the object is increased and output a signal to the control unit defining a threshold energy when changes of the structure or material of the inner surface of the object due to increased power of the first laser beam is detected, whereupon the control unit is configured to decrease the power of the first laser beam so that the energy exposed by the first laser beam to the inner surface of the object is below said threshold energy after said decreasing.

13. A device of claim 1, wherein the device comprises a control unit and a detecting device for detecting amount or depth of a layer of the material removed and for outputting a parameter describing the detected amount or depth to the control unit, said control unit being configured to control the rotation speed of the laser beam directing device, speed of the moving device and thereby the laser beam directing device inside the object moved by the moving device in the direction of the longitudinal axis, or parameters of the laser beam based on the parameter outputted by the detecting device in order to remove desired amount or depth of the material from the inside surface of the object.

14. A device of claim 1, wherein the device comprises a detecting device, such as a camera, determining reflections from the inner surface of the object and determine based on the reflections and brightness changes and thereby determine whether the material to be removed is removed or whether the material of the object itself is exposed to structural changes thereby changing the brightness of the reflected beam from the inner surface of the object.

15. A device of claim 1, wherein the device comprises a control unit controlling the laser beam to that the power or other parameter of the laser beam directed onto the inner surface is different in a first peripheral area than in a second peripheral area of the inner surface of the object.

16. A device of claim 1, wherein the moving device is configured to be supported onto the inner surface of the object and to move inside the object essentially parallel to the longitudinal axis of the object.

17. A device of claim 1, wherein the moving device is configured to align the laser beam directing device at the longitudinal axis of the object or next to the longitudinal axis of the object in order to focus the laser beam only to a certain arch of the inner surface perimeter of the object.

18. A device of claim 1, wherein the moving device comprises at least one wheel, tracks, like rubber tracks, rollers, at least one ski or at least one ball configured to support said moving device into the inner surface of the object in a movable manner, where the distances of which from the device are controllable thereby enabling the device suitable for different diameter objects.

19. A device of claim 1, wherein the moving device comprises a driving motor and a supplying device, for moving, such as pushing and/or pulling the laser beam directing device inside the object essentially in the longitudinal direction.

20. A device of claim 1, wherein the device comprises a cooling arrangement for cooling the laser beam directing device, wherein the cooling arrangement comprises a connection to an auxiliary cooling device and suitable channels and guiding deflectors to guide the cooling flow via the connection, channels and guiding deflectors to the laser beam directing device.

21. A device of claim 1, wherein the device comprises a fluid flow providing device configured to provide a fluid flow next to the laser beam directing device to keep an aperture area of the laser beam directing device clean from the material removed from the inner surface of the object by the device.

22. A device of claim 1, wherein the device comprises a transporting arrangement transporting the material removed from the inner surface of the object by the device, where the transporting arrangement may comprise a vacuum device for sucking the material away from the object.

23. A device of claim 1, wherein the moving device comprises an extendable and retractable leg coupled with the laser beam directing device, whereupon the extendable and retractable leg is configured to move the laser beam directing device in the direction of the longitudinal axis.

24. A method for manipulating an inner surface of an elongated object wall, said wall having a longitudinal axis essentially parallel with the inner surface of the object
wherein the method comprises steps of
directing a laser beam onto the inner surface of the object by a laser beam directing device to manipulate the inner surface of the cylindrical object and thereby provide structural changes to, remove a material from, or add material to said inner surface of the object at the location the laser beam directing device directing said laser beam, and
moving the laser beam directing device inside the object by a moving device thereby manipulating the inner surface of the object in the direction of the longitudinal axis.
